(19) United States
(12) Patent Application Publication
(10) Pub. No.: US 2005/0095404 A1
(43) Pub. Date: May 5, 2005

(54) Method of making a knobbed glass or glass ceramic plate, knobbed plate made thereby and tool for making the plate

(76) Inventors: Horst Schillert, Gruenenplan (DE); Dirk Roessler, Gruenenplan (DE); Detlef Mevers, Holzen (DE)

Correspondence Address: STRIKER, STRIKER & STENBY, 103 EAST NECK ROAD, HUNTINGTON, NY, 11743, US

(21) Appl. No.: 10/975,916

(22) Filed: Oct. 28, 2004

(30) Foreign Application Priority Data
Oct. 31, 2003 (DE) 103 51 718.9

(51) Int. Cl. B32B 3/10

(52) U.S. Cl. 428/178; 428/131

(57) ABSTRACT

The method of making a knobbed glass or glass ceramic plate includes placing a glass or glass ceramic plate on a support having knob-shaped elevations and/or depressions; jointly heating the plate and the support over a transformation temperature of the glass or glass ceramic plate and, advantageously after a certain time interval, subsequently cooling the plate to room temperature. The glass or glass ceramic plate with knobs made by the method is also part of the invention. The glass or glass ceramic plate with the knobs can be used in heating units, such as baking ovens, for thermal isolation or decoupling of differently heater spatial regions. Also it can be provided with a germ killing coating for use in an air conditioning unit to clean air.

### BACKGROUND OF THE INVENTION

1. Field of the Invention

The present invention relates to a method for making a knobbed plate from glass or a glass ceramic material, the knobbed plate made thereby and a tool used for that purpose. The knobbed plate can be used in a baking oven for thermal decoupling of the heated inner chamber from the colder exterior region (kitchen), and also for killing germs in air conditioning units.

2. Description of the Related Art

Different methods are available in the prior art for providing a glass plate with holes or cavities. It is possible to provide a glass plate with holes with conventional drills using a diamond drill bit.

Ultrasonic lapping is a generally known method for introducing only holes or cavities into a glass plate, which have a size of at maximum 25.4 cm (10 inches). The cavity size is very limited in this lapping method.

Generally sand blasting can introduce holes or cavities into a glass plate. Similarly laser methods can be used to produce individual holes of small diameter in glass.

### SUMMARY OF THE INVENTION

It is an object of the present invention to provide a method for rapidly manufacturing a glass or glass ceramic plate with a large number of holes or cavities of any arbitrarily selected shape.

It is also an object of the present invention to provide a knobbed glass plate and a method of making it.

It is an additional object of the present invention to provide a forming tool from making the knobbed glass plate according to the invention.

According to the present invention the technical problems related to providing the method for rapidly manufacturing the glass or glass ceramic plate of the above-described type are solved by a method comprising:
a) placing a plate on a support having knob-shaped elevations and/or depressions or cavities;
b) jointly heating the plate and the support over a transformation temperature; and
c) cooling the plate to room temperature.

The making of the plate occurs by placing the plate on a planar or flat support and by heating the support and plate to a sufficiently high temperature so that a plastic deformation of the plate occurs. If the support has knob-shaped elevations or projections, glass or glass ceramic material fills the spatial regions between the elevations or projections by viscous flow. Alternatively if the support has knob-shaped depressions or cavities, the glass or glass ceramic material heated to a sufficiently high temperature flows into these depressions or cavities. The surface of the support is mapped on the plate in this way. In this sense the support acts like a photographic negative and the plate as the positive (the photo).

The flat support has knob-like elevations or projections or depressions or cavities. The plate is provided with knobs at the positions on the support where the elevations/projections or depressions/cavities are located.

The term “knob” in the sense of the present invention means a displacement of material in a direction substantially perpendicular to the surface of the plate, which is hump-shaped. An observer would view the displacement of material as an elevation or projection with a generally arbitrarily shaped surface when viewing the plate from one side of the plate and as a cavity or recess from the other side of the plate.

To obtain exact knob geometry in the glass or glass ceramic plate the support itself should experience no temperature-related deformation. In other words, it should be sufficiently form stable at high temperature. Moreover the glass should experience only slight adherence to the support, so that the plate can be released from the support. A chromium-nickel steel, especially that with material number 1.4122 and carbon content between 0.20 and 0.25%, has proven satisfactory in this sense. Best results are obtained with additional tempering of the chromium-nickel-steel to 800 to 1000 N/m².

In order to guarantee slight adherence of the plate on the support, a separating agent can be used. Good results are obtained using boron nitride BN A 01 as separating agent for, among others, chromium-nickel steel.

It suffices or the method when the plate and the support are jointly heated so that they both exceed the transformation temperature. It is sufficient when the plate in a still heated state is placed on the support so that they can be subsequently heated jointly over the transformation temperature.

The speed of the manufacturing method generally is limited by the condition that not only the plate but also the support must be heated. For this reason the method is more rapid when the plate is placed on a pre-heated support.

In order to improve the filling of all spatial regions of the support between the knob-shaped elevations or the flowing of material into the knob-shaped depressions, a waiting time until cooling can be maintained after exceeding a set temperature above the transformation temperature. The glass needs a certain time in order to reach all depressions between knob-shaped elevations/projections or depressions/cavities. The maintaining of a waiting time improves the exact mapping of the support structure on the glass or glass ceramic plate.

In order to guarantee an exact shaping of the glass or glass ceramic plate by the support surface it is important that the glass or glass ceramic completely fill all spatial regions of the support between the knob-shaped elevations. In order to improve the filling of these regions of the support they can be acted on with suction or vacuum. The low pressure in these regions can be in a range of about 0.4 bar to about 0.6 bar. A suction or vacuum can act on the depressions In the case of knob-shaped depressions. In this case the plate material is the glass or glass ceramic material of the plate will be drawn into the depressions.

The low pressure can be produced in the support by equipping the support with through-going openings that connect the regions between the knob-shaped elevations or the knob-shaped depressions on one side of the plate with the other side of the plate and by producing a low pressure on the other side of the plate. In this way the glass or glass ceramic material will be drawn into the depressions or the regions between the elevations by the suction or low pressure on the rear or other side of the plate. In this way the material experiences a force in the direction of the support between the knob-shaped elevations or into the knob-shaped depressions, which leads to an improved filling of these regions with the glass or glass ceramic material.

In order to guarantee the exact mapping of the glass or glass ceramic material with the support surface additionally the plate can be acted on with a pressure. In this way the plate material is forced into regions between the knob-shaped elevations or into the depressions of the support.

In some embodiments the knobs of the cooled plate can be partially ground or sanded. In this way a knob with a through-going opening or a hole is produced. The grinding or sanding can take place by means of a grinding plate, diamond grinding disk, CNC-grinding machine with a diamond tool, or by means of a laser. When the grinding process is performed parallel to the plate surface openings with identical edge- shape or contour are produced in equal knobs.

A glass or glass ceramic plate with knobs is produced by the method according to the invention and is part of the present invention. The knobs are provided with arbitrary surfaces in their basic form and are hollow. However the knobs can have an open structure on both side. In this latter case the knobs have a through-going opening. The shape of the opening depends on the geometric shape of the knob and on the manner in which the top parts of the knobs are ground off. In the grinding process a part of the knob is abraded or ground off. Different shaped knobs, if necessary with different opening shapes, can be provided in a plate.

The glass or glass ceramic plates that can be equipped with knobs have a thickness of about 0.5 mm to about 60 mm. Good results were obtained when the knob-shaped elevations were slightly greater than the plate thickness, for example by about 1/10 mm.

The openings produced by grinding or abrading away a part of the knobs have a diameter of about 0.5 mm to 100 mm. The spatial form of the knobs can be such that they have a variable height. The knobs can have a circular or polygonal edge contour when the plate is observed. The knobs can further be polyhedral or truncated cone-shaped. In the case of truncated cone-shaped knobs it has proven suitable that the outer surface of knob is inclined at an angle from about 20° to about 85° relative to the base surface. For larger angles the surface area of an elevation of the support increases, which makes release of the glass or glass ceramic material from the support increasingly difficult.

From the foregoing disclosure it would seem that the glass or glass ceramic plate that is provided with the knobs should be planar in its basic form. However it is also possible to provide curved glass or glass ceramic plates with these sorts of knobs.

The support must be made from a material that has a stable form at high temperature in order to make the knobbed glass or glass ceramic plate. Materials which are suitable include chromium-nickel steel. The flat or planar tool is provided with through-going openings between the knob-shaped elevations to guarantee an exactly shaped mapping surface of the support.

In the method according to the invention a large number of openings can be provided in a comparatively short time, for example 1000 openings in a large plate of for example 1500 mm×1500 mm in size. The time required to provide the openings in a plate is only about 50 min.

Furthermore the knobbed plate can be coated, for example by means of a sputtering method with a metal oxide layer (e.g. such as a gold, chromium or titanium layer). On account of its large glass surface area the plate can then be provide with a suitable germ killing coating of the type for cleaning air in an air conditioner.

### BRIEF DESCRIPTION OF THE DRAWING

The objects, features and advantages of the invention will now be illustrated in more detail with the aid of the following description of the preferred embodiments, with reference to the accompanying figures in which:

FIG. 1 is a cross-sectional view through a support used in a preferred embodiment of the method of making a knobbed glass or glass ceramic plate according to the invention;

FIG. 2 is a partially side, partially cross-sectional cutaway view of a portion A of the support shown in FIG. 1;

FIG. 3 is a side view of a portion of the knobbed glass plate made with the support shown in FIGS. 1 and 2;

FIG. 4a is a side view of the portion of the knobbed glass plate shown in FIG. 3, which illustrates how the tops of the knobs on the glass plate are ground off with a grinding tool; and

FIG. 4b is a top plan view of the portion of knobbed glass plate with the tops ground off the knobs, as shown in FIG. 4a.

### DETAILED DESCRIPTION OF THE INVENTION

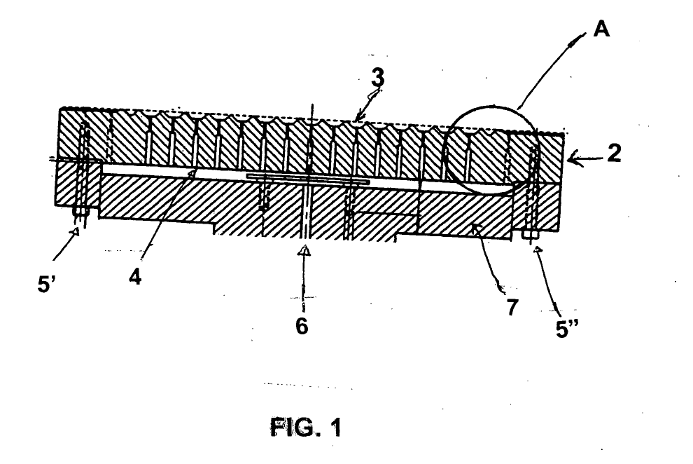

A support plate 2 for use in the method of making the knobbed glass or glass ceramic plate P is shown in FIG. 1. The support 2 has depressions 3 on one side (upper side as shown in FIG. 1), which are connected with the other side of the support 2, by through-going openings 4. The support 2 is connected with a base 7 by means of screws 5′, 5″. The depressions are maintained under a vacuum of 0.8 bar by suction by means of the vacuum line 6, which communicates with the space between the support 2 and the base 7.

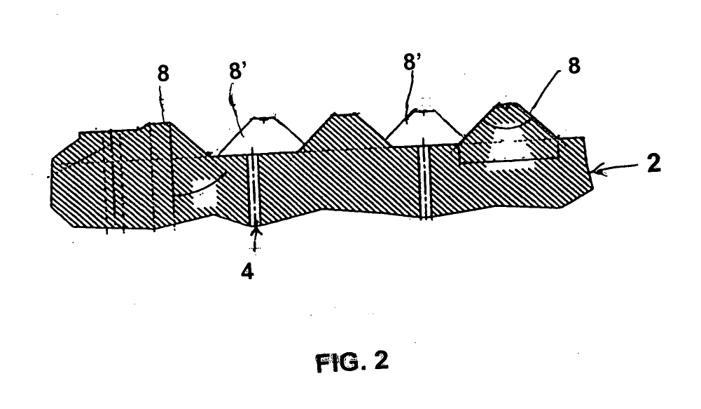

FIG. 2 shows a portion A of the support 2. The support 2 has knob-shaped elevations 8 and/or 8′. The elevations 8′ are positioned behind the elevations 8. The elevations 8, 8′ are frustrum-shaped or truncated cone-shaped. The elevations have a height of 5 mm and a cone angle of 45° in the preferred embodiment shown in FIG. 2.

In the method of making the knobbed glass plate a 2 mm thick and planar soda lime glass plate or panel with a transformation temperature of 630° C. is placed in a cold state on a support plate 2 made from chromium-nickel steel, which has been pre-heated to a temperature of 450° C. The support has truncated cone-shaped knobs with a height of 5 mm and a cone angle of 45°. The support and plate are introduced into an oven together and brought to a final temperature of 740° C. Then they are left in the oven for about 10 minutes. Subsequently a pre-defined cooling process takes place, in order to reduce thermal stresses in the glass.

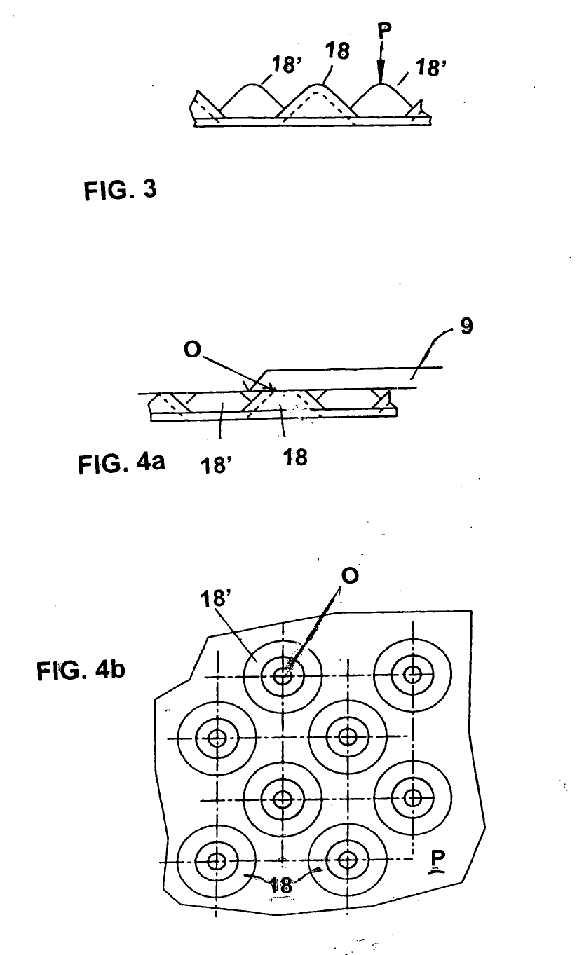

The knobbed soda lime glass plate P made with the support 2 by this method is shown in a side view in FIG. 3. The knobbed glass plate has front and rear knobs 18, 18′. which fit together with the elevations 8, 8′ of the support plate 2. The knobs are partially ground away, in order to provide the through-going openings O. In the case of the present invention the uppermost 2.1 mm of the knobs 18, 18′ are ground off with a band grinder 9 as shown in FIG. 4a.

The round or circular edge contour of the openings O is clearly shown in the top plan view of FIG. 4b. The dashed lines in the knobs 18, 18′ show the other side of the plate in the vicinity of the knobs, which of course bears on the elevations 8, 8′ of the support 2 during the formation of the knobbed glass plate shown in FIGS. 4a and 4b.

The knobbed glass plate is suitable for use in a baking oven for thermal decoupling of hot and less hot spatial regions, especially for decoupling the hot interior region of the oven from a kitchen area outside of the oven.

The disclosure in German Patent Application 103 51 718.9-45 of Oct. 31, 2003 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in a method of making a knobbed glass or glass ceramic plate, knobbed plate made thereby and tool for making the plate, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

1. A method of making a knobbed glass or glass ceramic plate, said method comprising the steps of:
a) placing a glass or glass ceramic plate on a support having knob-shaped elevations and/or depressions;
b) jointly heating the plate and the support over a transformation temperature of the glass or glass ceramic plate; and
c) subsequently cooling the plate to room temperature;
whereby said glass or glass ceramic plate is provided with a plurality of knobs.

2. The method as defined in claim 1, further comprising pre-heating said support prior to said placing of said glass or glass ceramic plate on said support.

3. The method as defined in claim 1 or 2, further comprising waiting for a predetermined time interval after reaching a set temperature above said transformation temperature during said heating of said plate and said support prior to starting said cooling.

4. The method as defined in claim 1, further comprising exposing regions of said support between said knob-shaped elevations and/or depressions to a low pressure.

5. The method as defined in claim 4, further comprising providing through-going openings in said support connecting said regions with a side of said support opposite from another side on which said regions are located.

6. The method as defined in claim 1, further comprising pressing said glass or glass ceramic plate on said support.

7. The method as defined in claim 1, further comprising grinding off a part of said knobs.

8. A glass or glass ceramic plate provided with knobs.

9. The plate as defined in claim 8, wherein said knobs are open on opposite sides thereof so that said knobs have respective knob openings on both of said sides.

10. The plate as defined in claim 9, wherein a smaller of said knob openings has a diameter of about 0.5 mm to about 100 mm.

11. The plate as defined in claim 8, wherein said knob openings have a circular or polygonal shape when said plate is viewed from a top side.

12. The plate as defined in claim 8, wherein said knobs are truncated cone-shaped or polyhedral.

13. The plate as defined in claim 8, wherein an outer surface of each of said knobs is inclined at an angle of from about 20° to about 85° relative to a base surface.

14. The plate as defined in claim 8, provided with a curved base surface on which said knobs are formed.

15. The plate as defined in claim 8, further comprising a coating on a surface thereof.

16. A flat tool for providing a glass or glass ceramic plate with a knobbed structure on a surface of said plate, wherein said flat tool is made of steel and is provided with knob-shaped elevations and/or depressions.

17. The flat tool as defined in claim 16, wherein said steel is chromium-nickel steel.

18. The flat tool as defined in claim 16 or 17, provided with through-going openings connecting regions between said knob-shaped elevations or said knob-shaped depressions on one side of the tool with another side of the tool opposite from said one side.

19. A heating producing unit comprising a glass or glass ceramic plate with knobs as defined in one of claims 8 to 15 and wherein said glass or glass ceramic plate with said knobs is arranged so as to thermally decouple a hot region of said unit in operation of the unit from another region.

20. The heat producing unit as defined in claim 19, consisting of a baking oven.

21. An air conditioner comprising a glass or glass ceramic plate with knobs as defined in one of claims 8 to 15 and wherein said glass or glass ceramic plate with said knobs is provided with means for killing germs to clean air therein.
